(19) United States
(12) Patent Application Publication
(10) Pub. No.: US 2026/0110667 A1
(43) Pub. Date: Apr. 23, 2026

(54) PREPARATIVE LIQUID CHROMATOGRAPH

(71) Applicant: SHIMADZU CORPORATION, Kyoto-shi (JP)

(72) Inventor: Iori OTOMO, Kyoto-shi (JP)

(21) Appl. No.: 19/328,952

(22) Filed: Sep. 15, 2025

(30) Foreign Application Priority Data
Oct. 22, 2024 (JP) 2024-185906

(51) Int. Cl. G01N 30/44; G01N 30/24; G01N 30/46; G01N 30/86

(52) U.S. Cl. CPC G01N 30/44; G01N 30/24; G01N 30/466; G01N 30/8634

(57) ABSTRACT

A preparative liquid chromatograph comprises a separation column, a detector for detecting sample components in an eluate from the separation column, a component trapping unit for introducing the eluate into any of a plurality of trap columns to trap the components, a recovery unit for recovering the eluate into a container, a flow path switching unit for switching a flow path to introduce the eluate to either the component trapping unit or the recovery unit, and a control unit for controlling the flow path switching unit to introduce the eluate into the component trapping unit until the number of components sequentially detected with a single sample introduction into the separation column becomes equal to the number of trap columns, and to introduce the eluate into the recovery unit after the number of the components has exceeded the number of trap columns.

### TECHNICAL FIELD

The present invention relates to a preparative liquid chromatograph.

### BACKGROUND ART

Preparative liquid chromatographs are known that utilize liquid chromatography to fractionate and collect one or more components (compounds) contained in a liquid sample. In a preparative liquid chromatograph, a sample is passed through a separation column along with a mobile phase to temporally separate the various components in the sample. The separated sample components are detected by a detector, such as a spectrophotometer, provided downstream of the separation column, and a chromatogram is created based on the detection signal. Then, peaks appearing on the chromatogram are detected from the waveform of the chromatogram, and each sample component is fractionated into a different container by opening and closing a solenoid valve of a fraction collector provided downstream of the detector in accordance with the start and end of the peak.

Some of these preparative liquid chromatographs are equipped with a function to concentrate the sample components separated by the separation column by trapping them in different trap columns (see, for example, Patent Document 1). The sample components trapped in each trap column are then eluted by passing a predetermined solvent through the trap column and recovered by the fraction collector. At this time, by using a solvent with high eluting power, the sample components collected in the trap column can be eluted in a short time (i.e., with a small amount of solvent), and a solution containing the sample components at a high concentration can be obtained. Furthermore, by using a highly volatile organic solvent or the like as the solvent, the subsequent step of evaporating the solvent to obtain the sample components in a solid state (drying step) can be performed in a short time.

### PRIOR ART DOCUMENT

### Patent Document

[Patent Document 1] Japanese Unexamined Patent Application Publication No. 2003-149217

### SUMMARY OF INVENTION

### Problem to be Solved by the Invention

However, in a preparative liquid chromatograph equipped with such trap columns, the number of components (strictly speaking, the number of types of components) that can be trapped in the trap columns with a single sample injection into the separation column depends on the number of trap columns. That is, if N trap columns are provided in the preparative liquid chromatograph, among the components sequentially eluting from the separation column, the first to N-th eluting components can be trapped in each of the N trap columns, but the (N+1)th and subsequent eluting components are discarded without being trapped by the trap columns. Therefore, there has been a problem that even if an important component exists among the (N+1)th and subsequent components, it cannot be recovered.

The present invention has been made in view of the above points, and an object thereof is to enable the recovery of N+1 or more types of sample components in a preparative liquid chromatograph equipped with N trap columns.

### Means for Solving the Problem

A preparative liquid chromatograph according to the present invention, which has been made to solve the above problem, comprises:
a separation column for separating components in a sample;
a detector for detecting the components in an eluate from the separation column;
a chromatogram creation unit for creating a chromatogram in real time based on a detection signal obtained by the detector;
a peak counting unit for sequentially counting peaks appearing on the chromatogram;
a component trapping unit having a plurality of trap columns, for selectively introducing the eluate into any of the plurality of trap columns to trap the components;
a recovery unit for recovering the eluate into a predetermined container;
a flow path switching unit for switching a flow path to introduce the eluate from the separation column into either the component trapping unit or the recovery unit;
a column number storage unit for storing the number of the plurality of trap columns provided in the component trapping unit;
a determination unit for determining whether or not the number of peaks sequentially counted by the peak counting unit with a single sample introduction into the separation column has exceeded the number of the plurality of trap columns; and
a control unit for controlling the flow path switching unit to introduce at least a portion of the eluate containing the component detected by the detector into the component trapping unit until it is determined by the determination unit that the number of peaks has exceeded the number of the plurality of trap columns, and to introduce at least a portion of the eluate containing the component detected by the detector into the recovery unit after it is determined that the number of peaks has exceeded the number of the plurality of trap columns.

### Effects of the Invention

According to the preparative liquid chromatograph of the present invention having the above configuration, when N trap columns are provided as the plurality of trap columns, among the peaks sequentially appearing on the chromatogram with a single sample introduction, the components corresponding to the first to N-th peaks are trapped in each of the N trap columns, and the components corresponding to the (N+1)th and subsequent peaks are recovered by the recovery unit. That is, in a preparative liquid chromatograph equipped with N trap columns, it becomes possible to recover N+1 or more types of sample components.

### BRIEF DESCRIPTION OF THE DRAWINGS

FIG. 1 is a diagram showing a schematic configuration of a preparative liquid chromatograph according to an embodiment of the present invention.

FIG. 2 is a block diagram showing a main part configuration of a control/processing unit in the same embodiment.

FIG. 3 is a part of a flowchart showing the operation of the preparative liquid chromatograph.

FIG. 4 is a continuation part of the flowchart of FIG. 3.

FIG. 5 is a diagram showing the flow of liquid before sample introduction in the same embodiment.

FIG. 6 is a diagram showing the flow of liquid when trapping a sample component in a trap column in the same embodiment.

FIG. 7 is a diagram showing the flow of liquid when performing direct recovery of a sample component in the same embodiment.

FIG. 8 is a diagram showing the flow of liquid when eluting a sample component from a trap column in the same embodiment.

FIG. 9 is a diagram showing a schematic configuration of a preparative liquid chromatograph according to another embodiment of the present invention.

FIG. 10 is a diagram showing a schematic configuration of a preparative liquid chromatograph according to still another embodiment of the present invention.

### DESCRIPTION OF EMBODIMENTS

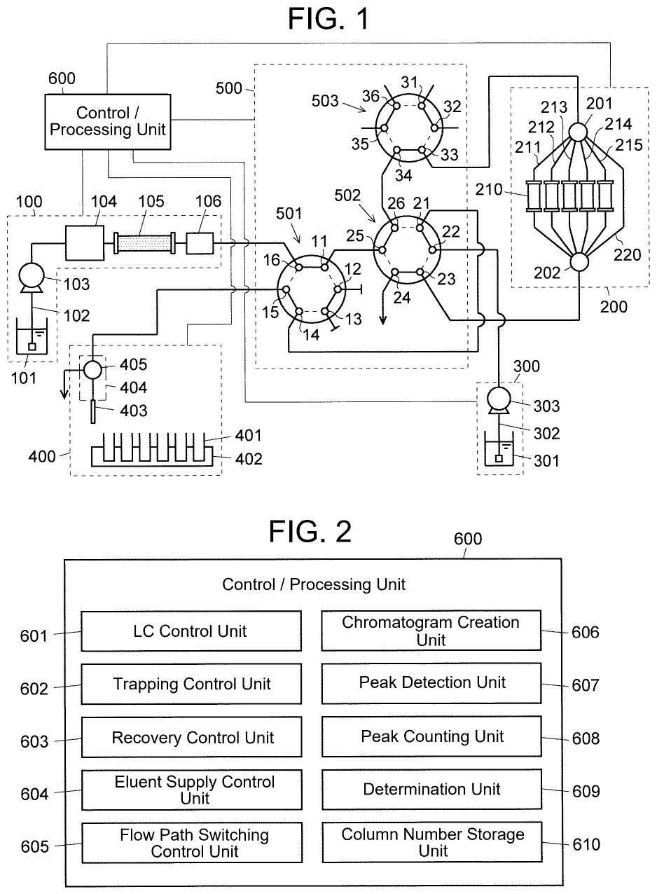

Hereinafter, embodiments for carrying out the present invention will be described with reference to the drawings. FIG. 1 is a schematic configuration diagram of a preparative liquid chromatograph according to this embodiment. This preparative liquid chromatograph includes an LC unit 100, a component trapping unit 200, an eluent supply unit 300, a fraction collector 400 (corresponding to the recovery unit in the present invention), a flow path switching unit 500, and a control/processing unit 600.

The LC unit 100 includes a mobile phase container 101, a mobile phase flow path 102, and, provided on the mobile phase flow path 102, a mobile phase supply pump 103 (corresponding to the mobile phase supply unit in the present invention), an automatic sample injection device 104, a separation column 105, and a detector 106. As the detector 106, various detectors used in liquid chromatography, such as, for example, an absorbance detector or a differential refractive index detector, can be used.

The component trapping unit 200 includes a plurality of trap column flow paths 211 to 215, each provided with one trap column 210, a waste liquid flow path 220 not provided with a trap column 210, a first column switching valve 201, and a second column switching valve 202. Each trap column 210 is filled with a trapping agent for trapping sample components. The first column switching valve 201 and the second column switching valve 202 each have one common port and a plurality of selection ports, and any one of the plurality of selection ports can be selectively connected to the common port. The plurality of trap column flow paths 211 to 215 and the waste liquid flow path 220 are provided in parallel with each other, one end of each flow path 211 to 215, 220 is connected to each of the plurality of selection ports of the first column switching valve 201, and the other end of each flow path 211 to 215, 220 is connected to each of the plurality of selection ports of the second column switching valve 202. The first column switching valve 201 and the second column switching valve 202 are synchronized, and when one valve selects any of the trap column flow paths 211 to 215 or the waste liquid flow path 220, the other valve also switches to select the same trap column flow path 211 to 215 or waste liquid flow path 220. Note that FIG. 1 and FIGS. 5 to 8 described later show a configuration in which five trap columns 210 are provided, but the number of trap columns 210 provided in the component trapping unit 200 is not limited to this, and may be four or less, or six or more.

The eluent supply unit 300 includes an eluent container 301 that stores an eluent (a solvent for eluting sample components) corresponding to the sample components trapped in the trap column 210, an eluent supply flow path 302, and an eluent supply pump 303 provided on the eluent supply flow path 302.

The fraction collector 400 includes a container housing unit 402 that houses a plurality of recovery containers 401, a nozzle head 404 with a dispensing nozzle 403 provided at its lower end, a dispensing valve 405 built into the nozzle head 404 that switches the liquid delivery destination to either a drain or the dispensing nozzle 403, and a drive unit (not shown) that moves the nozzle head 404 forward and backward, up and down, and left and right.

The flow path switching unit 500 includes a first flow path switching valve 501, a second flow path switching valve 502, and a third flow path switching valve 503. These are all 6-port valves, where the first flow path switching valve 501 has ports 11 to 16, the second flow path switching valve 502 has ports 21 to 26, and the third flow path switching valve 503 has ports 31 to 36. Further, these valves 501 to 503 can each connect a port to one of its adjacent ports by selectively switching between a state where the flow path inside the valve is connected as shown by the solid line in FIG. 1 (hereinafter referred to as the first state) and a state where it is connected as shown by the broken line in the same figure (hereinafter referred to as the second state). As shown in FIG. 1, port 11 of the first flow path switching valve 501 is connected to port 25 of the second flow path switching valve 502, and port 14 is connected to port 21 of the second flow path switching valve 502. Port 15 is connected to the dispensing valve 405 of the fraction collector 400, and the downstream end of the mobile phase flow path 102 is connected to port 16. Port 22 of the second flow path switching valve 502 is connected to the eluent supply pump 303, and port 23 is connected to the common port of the second column switching valve 202 of the component trapping unit 200. Port 24 is connected to a drain, and port 26 is connected to port 34 of the third flow path switching valve 503. Port 33 of the third flow path switching valve is connected to the common port of the first column switching valve 201 of the component trapping unit 200. Note that ports 12 and 13 of the first flow path switching valve 501 are closed. Also, although a liquid supply pump or the like for supplying cleaning liquid or diluent (not shown) is connected to ports 31, 32, 35, and 36 of the third flow path switching valve 503, a description thereof is omitted here.

The control/processing unit 600 is configured by a general-purpose computer such as a personal computer, a dedicated computer, or a combination thereof, and controls the above-mentioned units and performs predetermined data processing based on an output signal from the detector 106 of the LC unit 100. The configuration of the control/processing unit 600 is shown in FIG. 2. The control/processing unit 600 includes an LC control unit 601 that controls the LC unit 100, a trapping control unit 602 that controls the component trapping unit 200, a recovery control unit 603 that controls the fraction collector 400, an eluent supply control unit 604 that controls the eluent supply unit 300, a flow path switching control unit 605 that controls the flow path switching unit 500, a chromatogram creation unit 606 that creates a chromatogram in substantially real time based on the output signal from the detector 106, a peak detection unit 607 that detects the start and end points of peaks appearing on the chromatogram over time, a peak counting unit 608 that counts the peaks, and a determination unit 609 that performs a predetermined determination based on the count result. These are all functional blocks realized in software by a CPU provided in the computer constituting the control/processing unit 600 reading a dedicated program installed in a large-capacity storage device such as an HDD provided in the computer into the memory of the computer and executing it. Among these functional blocks, the recovery control unit 603 and the flow path switching control unit 605 correspond to the control unit in the present invention. Also, the recovery control unit 603 functions as the recovery unit control unit in the present invention, and the LC control unit 601 functions as the mobile phase supply control unit in the present invention. Furthermore, the control/processing unit 600 includes a column number storage unit 610 that stores the number of trap columns 210 provided in the component trapping unit 200 (hereinafter referred to as the number of trap columns). The function of the column number storage unit 610 is realized, for example, by a large-capacity storage device provided in the computer. Note that an input unit consisting of a keyboard or a mouse, and a display device consisting of a liquid crystal display or the like are connected to the computer (all not shown). The number of trap columns may be stored in advance in the column number storage unit 610 by the manufacturer of the preparative liquid chromatograph according to this embodiment, or a user may be allowed to input the number of trap columns via the input unit and that value may be stored in the column number storage unit 610.

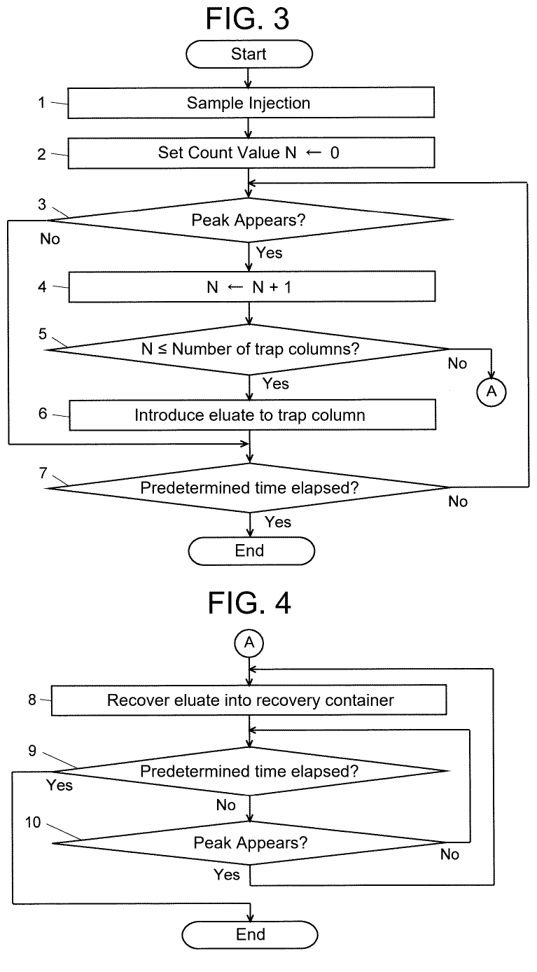

Next, the operation of the preparative liquid chromatograph according to this embodiment will be described with reference to the flowcharts of FIGS. 3 to 4 and FIGS. 5 to 8.

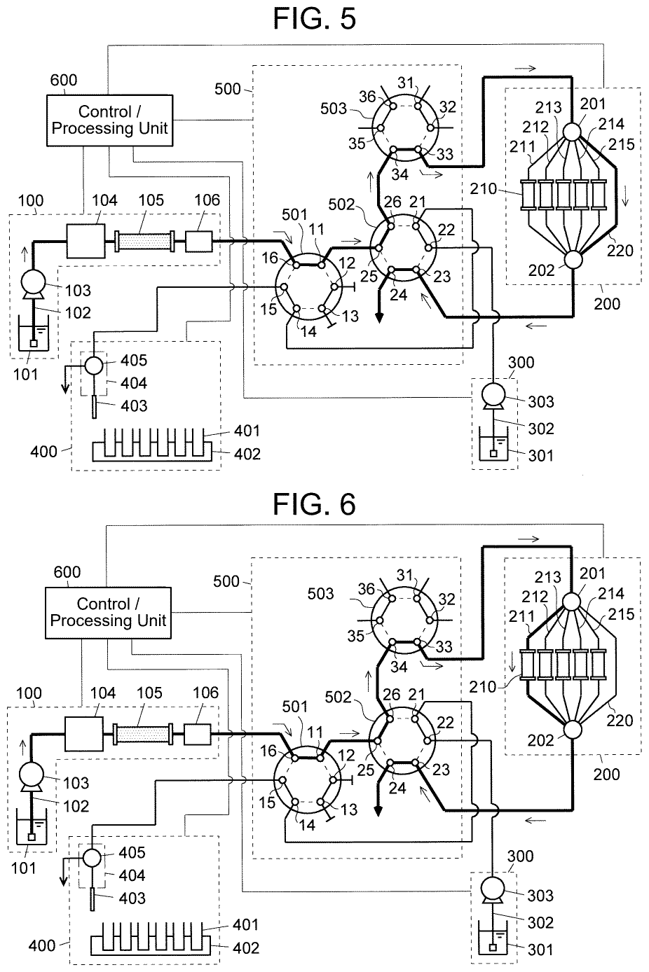

First, prior to sample injection, the supply of the mobile phase by the mobile phase supply pump 103 is started under the control of the LC control unit 601. At this time, the first flow path switching valve 501, the second flow path switching valve 502, and the third flow path switching valve 503 are all in the first state described above, and the first column switching valve 201 and the second column switching valve 202 are in a state where the waste liquid flow path 220 is selected. As a result, as shown in FIG. 5, the mobile phase drawn from the mobile phase container 101 by the mobile phase supply pump 103 is discharged to the drain via the automatic sample injection device 104, the separation column 105, the detector 106, the first flow path switching valve 501, the second flow path switching valve 502, the third flow path switching valve 503, the first column switching valve 201, the waste liquid flow path 220, the second column switching valve 202, and the second flow path switching valve 502.

Subsequently, under the control of the LC control unit 601, the automatic sample injection device 104 injects a predetermined amount of sample into the mobile phase flow path 102 (step 1). When the sample is injected, the peak counting unit 608 sets a processing variable, count value N, to 0 (step 2). The sample injected into the mobile phase flow path 102 is carried by the flow of the mobile phase and introduced into the inlet end of the separation column 105. Then, in the process of passing through the separation column 105, various components in the sample (hereinafter referred to as sample components) are separated and sequentially eluted from the outlet end of the separation column 105. The liquid flowing out from the outlet end of the separation column 105 (hereinafter referred to as eluate) is introduced into the detector 106. The output signal of the detector 106 is converted into a digital value by an A/D converter (not shown) and input to the control/processing unit 600.

In the control/processing unit 600, the chromatogram creation unit 606 starts creating a chromatogram showing the temporal change of the detection signal from the detector 106 based on the digital value. Then, the peak detection unit 607 determines at a predetermined time interval whether or not a peak has appeared on the chromatogram (step 3). The determination of whether a peak has appeared is made based on whether the start point of the peak has been detected on the chromatogram. The method for detecting the start point of a peak is not particularly limited, and any conventionally known method may be used, such as a method based on the signal level of the chromatogram, a method based on the slope of the chromatogram curve, or a method based on both.

When the peak detection unit 607 determines that a peak has appeared (i.e., Yes in step 3), the peak counting unit 608 increments the aforementioned count value N (step 4). Then, the determination unit 609 determines whether or not the count value N, that is, the number of peaks currently detected for the sample injected in step 1, is less than or equal to the number of trap columns stored in the column number storage unit 610 (step 5).

If it is determined that the count value N is less than or equal to the number of trap columns (i.e., Yes in step 5), the trapping control unit 602 controls the component trapping unit 200 to trap the portion of the eluate from the separation column 105 corresponding to the peak in the trap column 210 corresponding to the count value N (step 6). Here, the trap column 210 corresponding to the count value N means the N-th one of the plurality of trap columns 210 provided in the component trapping unit 200. For example, in step 6, if the count value N is 1, the trapping control unit 602 controls the first column switching valve 201 and the second column switching valve 202 to select the trap column flow path 211 where the first trap column 210 is provided, and if the count value N is 2, it controls the first column switching valve 201 and the second column switching valve 202 to select the trap column flow path 212 where the second trap column 210 is provided. As a result, as shown in FIG. 6, the eluate that has eluted from the separation column 105 and passed through the detector 106, the first flow path switching valve 501, the second flow path switching valve 502, and the third flow path switching valve 503 is introduced into the flow path where the trap column 210 corresponding to the count value N is provided (in the figure, the trap column flow path 211), and as the eluate passes through the trap column 210, the sample component corresponding to the peak is trapped in the trap column 210. The eluate that has passed through the trap column 210 is discharged to the drain via the second column switching valve 202 and the second flow path switching valve 502. Note that the switching of the first column switching valve 201 and the second column switching valve 202 as described above is performed at a timing that takes into account the time required for the eluate to reach the first column switching valve 201 from the detector 106 (hereinafter referred to as delay time).

Thereafter, when the peak detection unit 607 detects the end point of the peak, the trapping control unit 602 switches the first column switching valve 201 and the second column switching valve 202 to select the waste liquid flow path 220 again at a timing that takes into account the delay time. As a result, the eluate from the separation column 105 is discharged from the drain via the waste liquid flow path 220 and the second flow path switching valve 502. The method for detecting the end point of a peak is also not particularly limited, and any conventionally known method may be used, such as a method based on the signal level of the chromatogram, a method based on the slope of the chromatogram curve, or a method based on both.

Subsequently, it is determined whether or not a predetermined time has elapsed since the sample injection (step 7), and if it is determined that it has not elapsed, the process returns to step 3.

Thereafter, the processing of steps 3 to 7 is repeatedly executed until it is determined in step 7 that the predetermined time has elapsed, or until it is determined in step 5 that the count value N has exceeded the number of trap columns (i.e., until step 5 becomes No). Then, when it is determined in step 7 that the predetermined time has elapsed, the series of processes is terminated.

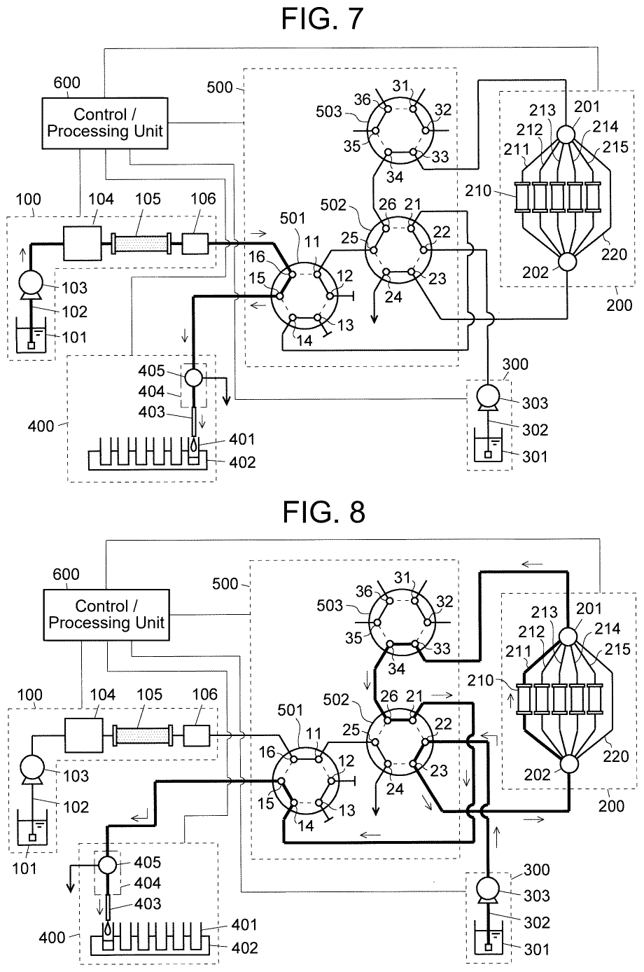

On the other hand, if it is determined in step 5 that the count value N is not less than or equal to the number of trap columns (i.e., it has exceeded the number of trap columns), the flow path switching control unit 605 and the recovery control unit 603 control the flow path switching unit 500 and the fraction collector 400 to recover the portion of the eluate from the separation column 105 corresponding to the peak into a recovery container 401 in the fraction collector 400 (step 8). Specifically, as shown in FIG. 7, the first flow path switching valve 501 is switched to the second state described above so that the eluate from the separation column 105 flows into the fraction collector 400 via the first flow path switching valve 501, and the nozzle head 404 of the fraction collector 400 is moved over a predetermined recovery container 401. Then, the dispensing valve 405 is switched at the timing when the portion of the eluate corresponding to the start point of the peak reaches the dispensing valve 405 to discharge the eluate from the dispensing nozzle 403, and the dispensing valve 405 is switched at the timing when the portion corresponding to the end point of the peak reaches the dispensing valve 405 to discharge the eluate reaching the dispensing valve 405 thereafter to the drain side. As a result, the portion of the eluate from the separation column 105 corresponding to the peak for which it was determined that the number of trap columns was exceeded is recovered in the recovery container 401 without being sent to the component trapping unit 200. Recovering the eluate from the separation column 105 into the recovery container 401 without sending it to the component trapping unit 200 in this way is hereinafter referred to as direct recovery.

Thereafter, it is determined whether or not a predetermined time has elapsed since the sample injection (step 9), and if it is determined that it has not elapsed, it is determined whether or not a peak has appeared on the chromatogram (step 10). If the peak detection unit 607 determines that a new peak has appeared on the chromatogram (i.e., Yes in step 10), the process returns to step 8, and the portion of the eluate from the separation column 105 corresponding to that peak is directly recovered into the same recovery container 401 as before. Note that since the first flow path switching valve 501 has been set to the second state described above by executing step 8 once, and the nozzle head 404 is in a state of being positioned above the recovery container 401, when executing step 8 for the second time and thereafter, it is only necessary to switch the dispensing valve 405.

Thereafter, steps 8 to 10 are repeatedly executed until it is determined that a predetermined time has elapsed since the sample injection (i.e., until Yes in step 9). Then, when it is determined in step 9 that the predetermined time has elapsed, the series of processes is terminated.

The sample components trapped in each trap column 210 by the above process (hereinafter referred to as trapping/recovery step) are thereafter eluted from each trap column 210, introduced into the fraction collector 400, and recovered in a different recovery container 401 for each trap column 210. Specifically, as shown in FIG. 8, the flow path switching control unit 605 and the trapping control unit 602 set the first flow path switching valve 501 and the third flow path switching valve 503 to the first state, respectively, and set the second flow path switching valve 502 to the second state, and at the same time, set the first column switching valve 201 and the second column switching valve 202 to a state where the trap column flow path 211 in which the first trap column 210 is provided is selected. Then, under the control of the eluent supply control unit 604, eluent is supplied from the eluent container 301 by the eluent supply pump 303, and the eluent is introduced into the trap column flow path 211 in which the first trap column 210 is provided via the second flow path switching valve 502 and the second column switching valve 202. As a result, the sample components trapped in the first trap column 210 are eluted from the column and introduced into the fraction collector 400 together with the eluent via the first column switching valve 201, the third flow path switching valve 503, the second flow path switching valve 502, and the first flow path switching valve 501, and recovered in a predetermined recovery container 401 in the fraction collector 400 (different from the recovery container used in step 8).

After completing the elution of the sample components trapped in the first trap column 210 from the trap column 210 and their recovery into the recovery container 401 as described above, the flow paths provided with the remaining trap columns 210 (in this embodiment, the trap column flow paths 212 to 215 provided with the second to fifth trap columns 210) are sequentially selected by switching the first column switching valve 201 and the second column switching valve 202, while the sample components are eluted from each trap column 210, and the solution containing the eluted sample components is recovered in a different recovery container 401 for each trap column 210. The process of eluting the sample components trapped in the trap column 210 from the trap column 210 and recovering them into the recovery container 401 as described above is hereinafter referred to as the elution step. It is desirable that the fraction collector 400 houses in advance a number of recovery containers 401 equal to or greater than the number of trap columns +1, so that the processing from the start of the trapping/recovery step to the end of the elution step can be performed continuously.

Thereafter, if there is a component that has been directly recovered in the above trapping/recovery step (i.e., the component recovered in step 8), the user takes out the recovery container 401 containing that component from the fraction collector 400 and sets it in the automatic sample injection device 104, and the liquid in the recovery container 401 (hereinafter referred to as direct recovery fraction) is reinjected into the mobile phase flow path 102 by the automatic sample injection device 104. Then, using the direct recovery fraction as a sample, the trapping/recovery step shown in the flowchart described above is executed again (this step is hereinafter referred to as recapturing/recovery step). By this recapturing/recovery step, one or more components contained in the direct recovery fraction are trapped in different trap columns 210 for each component. Therefore, by subsequently performing the elution step described above for each trap column 210, each sample component contained in the direct recovery fraction can be recovered in a different recovery container 401 for each component. In this recapturing/recovery step, the mobile phase conditions may be different from the mobile phase conditions in the trapping/recovery step. Here, the mobile phase conditions include the composition of the mobile phase, the flow rate of the mobile phase, the liquid pressure of the mobile phase, and the like. Also, in the case of performing so-called gradient elution, in which a plurality of solvents with different properties, such as water and an organic solvent, are mixed and the mixing ratio is changed over time and sent to the separation column 105, the gradient profile that defines the target value of the mobile phase composition (the mixing ratio of the plurality of solvents) over time becomes the mobile phase condition. Since the directly recovered components are components whose elution from the separation column 105 was slow in the trapping/recovery step, in the recapturing/recovery step, by setting the mobile phase conditions so that the components elute faster, the time required for the recapturing/recovery step can be shortened. If the direct recovery fraction contains a number of components exceeding the number of trap columns, the excess components will be directly recovered again in a predetermined single recovery container 401 in the fraction collector 400 in the recapturing/recovery step. In that case, after performing the elution step described above, the trapping/recovery step and the elution step are repeatedly executed using the direct recovery fraction in the recovery container 401 as a sample again, as shown in the flowchart described above, until the number of components eluting from the separation column 105 becomes equal to or less than the number of trap columns.

As described above, according to the preparative chromatograph of this embodiment, it is possible to separate and recover N+1 or more types of sample components from each other using N trap columns. This makes it possible to reliably recover an important component even if it exists among the components eluting from the separation column 105 as the (N+1)th or later component.

Although the embodiments for carrying out the present invention have been described above with specific examples, the present invention is not limited to the above embodiments, and appropriate modifications are permissible within the spirit of the present invention.

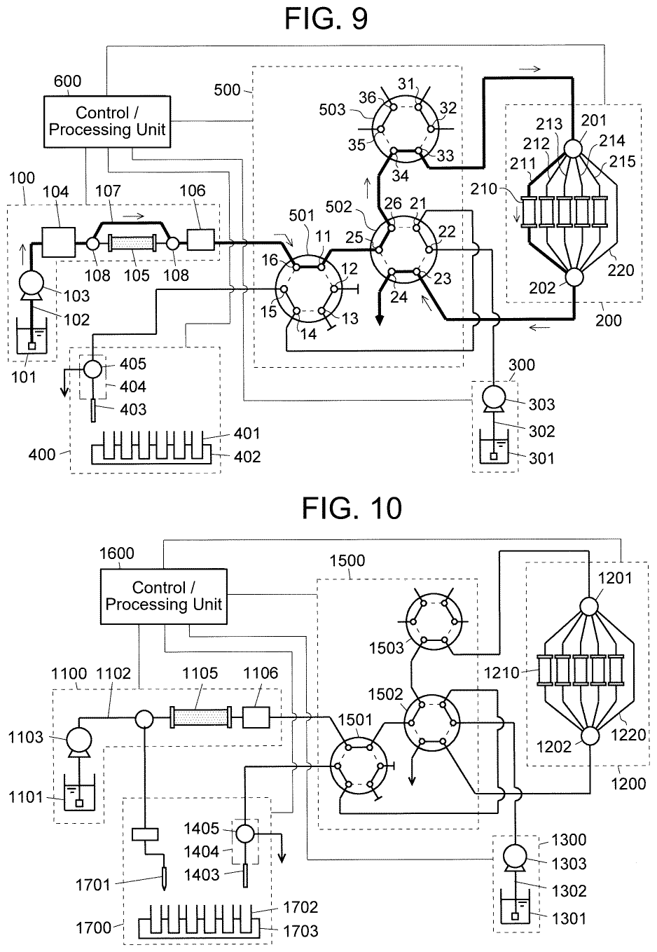

For example, in the above embodiment, after it is determined in step 5 of the flowchart that the count value N has exceeded the number of trap columns, all of the sample components corresponding to each of the subsequently detected peaks are recovered in a single recovery container 401. However, the invention is not limited to this, and after it is determined that the count value N has exceeded the number of trap columns, the components corresponding to each of the subsequently detected peaks may be recovered in different recovery containers 401. In this case, since each direct recovery fraction can then be introduced into the component trapping unit 200 without passing through the separation column 105 to trap the sample components in the direct recovery fraction in the trap column 210, the time required for processing the direct recovery fractions can be shortened. In that case, it is desirable that the preparative chromatograph according to the present invention has a configuration in which the LC unit 100 is provided with a bypass flow path 107 that bypasses the separation column 105 and a switching unit 108 for selectively switching whether to send the mobile phase supplied by the mobile phase supply pump 103 and the sample injected by the automatic sample injection device 104 to the separation column 105 or the bypass flow path 107, as shown in FIG. 9. According to such a configuration, by reinjecting the direct recovery fraction into the mobile phase flow path 102 by the automatic sample injection device 104 with the bypass flow path 107 selected by the switching unit 108, the direct recovery fraction can be sent to the component trapping unit 200 without passing through the separation column 105.

Further, in the above embodiment, the sample is automatically injected into the mobile phase flow path 102 by the automatic sample injection device 104. However, the invention is not limited to this, and a configuration in which a user manually injects the sample into the mobile phase flow path 102 with a manual injector may be adopted.

Alternatively, in place of the automatic sample injection device 104 and the fraction collector 400, a liquid handler that combines the functions of both may be provided. A configuration example in this case will be described with reference to FIG. 10. In this figure, the same or corresponding components as those shown in FIG. 1 are given reference numerals whose last three digits are common, and descriptions thereof are omitted as appropriate. The configuration of the control/processing unit 1600 is the same as that of the control/processing unit 600 shown in FIG. 2, so its illustration is omitted here. A liquid handler 1700 (corresponding to the recovery unit in the present invention) has a sampling needle 1701 and a dispensing nozzle 1403, a drive mechanism (not shown) for driving them, and a container housing unit 1703 that houses a plurality of containers 1702. The sampling needle 1701 collects liquid (sample) from any of the plurality of containers 1702 and injects it into the mobile phase flow path 1102, and the dispensing nozzle 1403 discharges the liquid sent from the LC unit 1100 (i.e., the eluate from the separation column 1105) or the liquid sent from the component trapping unit 1200 (i.e., the eluent containing the sample components eluted from the trap column 1210) into any of the plurality of containers 1702. In the configuration provided with such a liquid handler 1700, in step 8 described above, the eluate from the separation column 1105 is discharged from the dispensing nozzle 1403 into any of the plurality of containers 1702 to perform the direct recovery described above, and in the subsequent recapturing/recovery step, the direct recovery fraction in the container 1702 is collected by the sampling needle 1701 and reinjected into the mobile phase flow path 1102. This eliminates the need for the user to manually move the recovery container 401 containing the direct recovery fraction from the fraction collector 400 to the automatic sample injection device 104 when performing the recapturing/recovery step as in the above embodiment, thereby reducing the user's workload. Even in such a configuration, similarly to the above, the mobile phase conditions in the recapturing/recovery step may be different from the mobile phase conditions in the trapping/recovery step. In this case, the mobile phase supply pump 1103 corresponds to the mobile phase supply unit in the present invention, and the LC control unit 601 functions as the mobile phase supply control unit in the present invention.

Further, in the above embodiment, it is assumed that a program for realizing the functions of the present invention is pre-installed in a computer, but it is also possible to provide the program stored in a computer-readable recording medium (a non-transitory computer-readable recording medium).

### Aspects

It will be apparent to those skilled in the art that the exemplary embodiments described above are specific examples of the following aspects.

(First Aspect) A preparative liquid chromatograph according to one aspect of the present invention comprises:
a separation column for separating components in a sample;
a detector for detecting the components in an eluate from the separation column;
a chromatogram creation unit for creating a chromatogram in real time based on a detection signal obtained by the detector;
a peak counting unit for sequentially counting the peaks appearing on the chromatogram;
a component trapping unit having a plurality of trap columns, for selectively introducing the eluate into any of the plurality of trap columns to trap the components;
a recovery unit for recovering the eluate into a predetermined container;
a flow path switching unit for switching a flow path to introduce the eluate from the separation column into either the component trapping unit or the recovery unit;
a column number storage unit for storing the number of the plurality of trap columns provided in the component trapping unit;
a determination unit for determining whether or not the number of peaks sequentially counted by the peak counting unit with a single sample introduction into the separation column has exceeded the number of the plurality of trap columns; and
a control unit for controlling the flow path switching unit to introduce at least a portion of the eluate containing the component detected by the detector into the component trapping unit until it is determined by the determination unit that the number of peaks has exceeded the number of the plurality of trap columns, and to introduce at least a portion of the eluate containing the component detected by the detector into the recovery unit after it is determined that the number of peaks has exceeded the number of the plurality of trap columns.

According to the preparative liquid chromatograph of the first aspect, when N trap columns are provided as the plurality of trap columns, among the components sequentially eluting from the separation column, the first to N-th eluting components are trapped in each of the N trap columns, and the (N+1)th and subsequent eluting components are recovered by the recovery unit. This makes it possible to recover N+1 or more types of sample components in a preparative liquid chromatograph equipped with N trap columns.

(Second Aspect) The preparative liquid chromatograph according to the second aspect is
the preparative liquid chromatograph according to the first aspect, wherein
the recovery unit holds a plurality of the containers, and
the control unit controls the recovery unit to, after the flow path is switched by the flow path switching unit to introduce the eluate into the recovery unit, collectively recover portions of the eluate corresponding to each of the components detected by the detector into any one of the plurality of containers.

According to the preparative liquid chromatograph of the second aspect, even when there are multiple components eluting as the (N+1)th and subsequent components, the number of containers used can be suppressed. In addition, since the plurality of components contained in the direct recovery fraction recovered in the container can be reinjected into the mobile phase flow path together for separation by the separation column and trapping of the sample components by the trap columns, the time required for reinjection of the direct recovery fraction can be shortened.

(Third Aspect) The preparative liquid chromatograph according to the third aspect is the preparative liquid chromatograph according to the first aspect, wherein
the recovery unit holds a plurality of the containers, and
the control unit controls the recovery unit to, after the flow path is switched by the flow path switching unit to introduce the eluate into the recovery unit, individually recover portions of the eluate corresponding to each of the components detected by the detector into each of the plurality of containers.

According to the preparative liquid chromatograph of the third aspect, since each of the (N+1)th and subsequent eluting components is recovered in a separate container, the liquid in each container (direct recovery fraction) can thereafter be introduced into the component trapping unit without passing through the separation column to trap the sample components in each direct recovery fraction in a trap column. Therefore, the time required for processing each direct recovery fraction can be shortened.

(Fourth Aspect) The preparative liquid chromatograph according to the fourth aspect is the preparative liquid chromatograph according to any one of the first to third aspects, further comprising:
a recovery unit control unit for controlling the recovery unit to inject the eluate recovered in the predetermined container into a flow path leading to the separation column,
wherein the recovery unit further comprises an injection mechanism for injecting liquid into the flow path leading to the separation column.

According to the preparative liquid chromatograph of the fourth aspect, when reinjecting the direct recovery fraction into the mobile phase flow path, there is no need for the user to manually move the container housing the direct recovery fraction, thus reducing the user's workload.

(Fifth Aspect) The preparative liquid chromatograph according to the fifth aspect is the preparative liquid chromatograph according to the fourth aspect, further comprising:
a mobile phase supply unit for supplying a mobile phase to the flow path leading to the separation column; and
a mobile phase supply control unit for controlling the mobile phase supply unit so that mobile phase conditions when injecting the eluate recovered in the predetermined container into the flow path leading to the separation column and separating it with the separation column are different from mobile phase conditions when the eluate was recovered.

According to the preparative liquid chromatograph of the fifth aspect, by setting the mobile phase conditions when injecting the eluate recovered in the predetermined container into the flow path leading to the separation column and separating it with the separation column to be conditions under which the components contained in the eluate elute from the separation column faster than when the eluate was recovered, the fractionation time can be shortened.

### REFERENCE SIGNS LIST

100 . . . LC unit
104 . . . Automatic sample injection device
105 . . . Separation column
106 . . . Detector
200 . . . Component trapping unit
201 . . . First column switching valve
202 . . . Second column switching valve
210 . . . Trap column
300 . . . Eluent supply unit
400 . . . Fraction collector
401 . . . Recovery container
403 . . . Dispensing nozzle
500 . . . Flow path switching unit
600 . . . Control/processing unit
601 . . . LC control unit
602 . . . Trapping control unit
603 . . . Recovery control unit
604 . . . Eluent supply control unit
605 . . . Flow path switching control unit
606 . . . Chromatogram creation unit
607 . . . Peak detection unit
608 . . . Peak counting unit
609 . . . Determination unit
610 . . . Column number storage unit

1. A preparative liquid chromatograph, comprising:
a separation column for separating components in a sample;
a detector for detecting the components in an eluate from the separation column;
a chromatogram creation unit for creating a chromatogram in real time based on a detection signal obtained by the detector;
a peak counting unit for sequentially counting peaks appearing on the chromatogram;
a component trapping unit having a plurality of trap columns, for selectively introducing the eluate into any of the plurality of trap columns to trap the components;
a recovery unit for recovering the eluate into a predetermined container;
a flow path switching unit for switching a flow path to introduce the eluate from the separation column into either the component trapping unit or the recovery unit;
a column number storage unit for storing the number of the plurality of trap columns provided in the component trapping unit;
a determination unit for determining whether or not the number of peaks sequentially counted by the peak counting unit with a single sample introduction into the separation column has exceeded the number of the plurality of trap columns; and
a control unit for controlling the flow path switching unit to introduce at least a portion of the eluate containing the component detected by the detector into the component trapping unit until it is determined by the determination unit that the number of peaks has exceeded the number of the plurality of trap columns, and to introduce at least a portion of the eluate containing the component detected by the detector into the recovery unit after it is determined that the number of peaks has exceeded the number of the plurality of trap columns.

2. The preparative liquid chromatograph according to claim 1, wherein
the recovery unit holds a plurality of the containers, and
the control unit controls the recovery unit to, after the flow path is switched by the flow path switching unit to introduce the eluate into the recovery unit, collectively recover portions of the eluate corresponding to each of the components detected by the detector into any one of the plurality of containers.

3. The preparative liquid chromatograph according to claim 1, wherein
the recovery unit holds a plurality of the containers, and
the control unit controls the recovery unit to, after the flow path is switched by the flow path switching unit to introduce the eluate into the recovery unit, individually recover portions of the eluate corresponding to each of the components detected by the detector into each of the plurality of containers.

4. The preparative liquid chromatograph according to claim 1, wherein the recovery unit further comprises an injection mechanism for injecting liquid into a flow path leading to the separation column,
the preparative liquid chromatograph further comprising a recovery unit control unit for controlling the recovery unit to inject the eluate recovered in the predetermined container into the flow path leading to the separation column.

5. The preparative liquid chromatograph according to claim 4, further comprising:
a mobile phase supply unit for supplying a mobile phase to the flow path leading to the separation column; and
a mobile phase supply control unit for controlling the mobile phase supply unit so that mobile phase conditions when injecting the eluate recovered in the predetermined container into the flow path leading to the separation column and separating it with the separation column are different from mobile phase conditions when the eluate was recovered.
